(19) United States
(12) Patent Application Publication
(10) Pub. No.: US 2010/0279714 A1
(43) Pub. Date: Nov. 4, 2010

(54) METHODS AND SYSTEMS FOR CDMA EVDO PAGING INTERVAL ALIGNMENT WITH AN OVERLAID WIMAX NETWORK

(75) Inventors: Tom Chin, San Diego, CA (US); Guangming Shi, San Diego, CA (US); Kuo-Chun Lee, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/434,548

(22) Filed: May 1, 2009

(51) Int. Cl. H04B 1/40; H04W 4/00

(52) U.S. Cl. 455/458; 455/574

(57) ABSTRACT

Certain embodiments of the present disclosure provide a method for communicating, by a multi-mode mobile station (MS), with first and second networks via first and second radio access technologies (RATs). The method generally includes determining a first set of one or more paging parameters in an effort to establish a listening interval of a sleep cycle of the first network that aligns with a sleep interval of a control channel cycle of the second network and communicating the first set of paging parameters to a base station of the first network in a request to establish the sleep cycle of the first network.

### TECHNICAL FIELD

Certain embodiments of the present disclosure generally relate to wireless communication and, more particularly, to a multi-mode mobile stations entering into a sleep mode.

### SUMMARY

Certain embodiments of the present disclosure provide a method for communicating, by a multi-mode mobile station (MS), with first and second networks via first and second radio access technologies (RATs). The method generally includes determining a first set of one or more paging parameters in an effort to establish a listening interval of a sleep cycle of the first network that aligns with a sleep interval of a control channel cycle of the second network and communicating the first set of paging parameters to a base station of the first network in a request to establish the sleep cycle of the first network.

Certain embodiments of the present disclosure provide an apparatus for communicating with first and second networks via first and second radio access technologies (RATs). The apparatus generally includes logic for determining a first set of one or more paging parameters in an effort to establish a listening interval of a sleep cycle of the first network that aligns with a sleep interval of a control channel cycle of the second network and logic for communicating the first set of paging parameters to a base station of the first network in a request to establish the sleep cycle of the first network.

Certain embodiments of the present disclosure provide an apparatus for communicating with first and second networks via first and second radio access technologies (RATs). The apparatus generally includes means for determining a first set of one or more paging parameters in an effort to establish a listening interval of a sleep cycle of the first network that aligns with a sleep interval of a control channel cycle of the second network and means for communicating the first set of paging parameters to a base station of the first network in a request to establish the sleep cycle of the first network.

Certain embodiments of the present disclosure provide a computer program product for communicating with first and second networks via first and second radio access technologies (RATs), the computer program product comprising a computer-readable medium having instructions stored thereon, the instructions being executable by one or more processors. The instructions generally include instructions for determining a first set of one or more paging parameters in an effort to establish a listening interval of a sleep cycle of the first network that aligns with a sleep interval of a control channel cycle of the second network and instructions for communicating the first set of paging parameters to a base station of the first network in a request to establish the sleep cycle of the first network.

In certain embodiments of the present disclosure as presented herein, including the summary paragraphs above, one RAT can include a RAT in accordance with one or more standards of the Institute of Electrical and Electronics Engineers (IEEE) 802.16 family of standards and one RAT can include a code division multiple access evolution-data optimized (CDMA EVDO) RAT.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology in accordance with certain embodiments of the present disclosure.

FIG. 4 illustrates an example WiMAX network overlaid on a code division multiple access (CDMA) 1x network.

FIGS. 5A-B illustrate aspects of a CDMA EVDO control channel cycle under revision 0 and revision A of the CDMA EVDO standard.

FIG. 6 illustrates example operations for configuring a WiMAX sleep mode.

FIG. 6A is a block diagram of means corresponding to the example operations of FIG. 6.

FIG. 7 illustrates a cross-referencing of the timing between a CDMA EVDO network and a WiMAX network, in accordance with embodiments of the present disclosure.

FIG. 8 illustrates an example of a WiMAX sleep cycle in which some of the sleep windows cover the intervals of the control channel cycle of a CDMA EVDO network.

FIG. 9A illustrates a mobile sleep request message being sent more than 127 frames prior to the desired start frame.

FIG. 9B illustrates a mobile sleep request message being sent 127 frames prior to the next WiMAX absolute frame number with the least significant 8 bits identical to a previously determined 8-bit start frame number.

### DETAILED DESCRIPTION

Orthogonal frequency-division multiplexing (OFDM) and orthogonal frequency division multiple access (OFDMA) wireless communication systems, such as those compliant with the IEEE 802.16 family of standards, typically use a network of base stations to communicate with wireless devices (i.e., mobile stations) registered for services in the systems based on the orthogonality of frequencies of multiple subcarriers and can be implemented to achieve a number of technical advantages for wideband wireless communications, such as resistance to multipath fading and interference. Each base station (BS) emits and receives radio frequency (RF) signals that convey data to and from the mobile stations (MS).

In order to expand the services available to subscribers, some MSs support communications with multiple radio access technologies (RATs). For example, a multi-mode MS may support WiMAX and code division multiple access (CDMA) for broadband data services.

As a result of supporting multiple RATs, there may be instances in which a multi-mode MS may be in sleep mode in both a CDMA and the WiMAX networks. This may require the MS to listen for traffic indication or paging messages in both networks. Unfortunately, a multi-mode MS with a single RF chain may only listen to one system at a time.

Embodiments of the present disclosure may allow a multi-mode mobile station (MS) supporting both WiMAX and CDMA radio access technologies (RATs), for example, to configure a sleep cycle with respect to one of the RATs in such a way as to align sleep intervals of the sleep cycle with paging intervals scheduled with the other RAT. Specifically, embodiments may provide a method and apparatus allowing a multi-mode MS to determine a set of sleep parameters corresponding to the first RAT and negotiate a sleep cycle with the first RAT based on the sleep parameters such that the sleep intervals of the sleep cycle align with the paging intervals of the other RAT.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

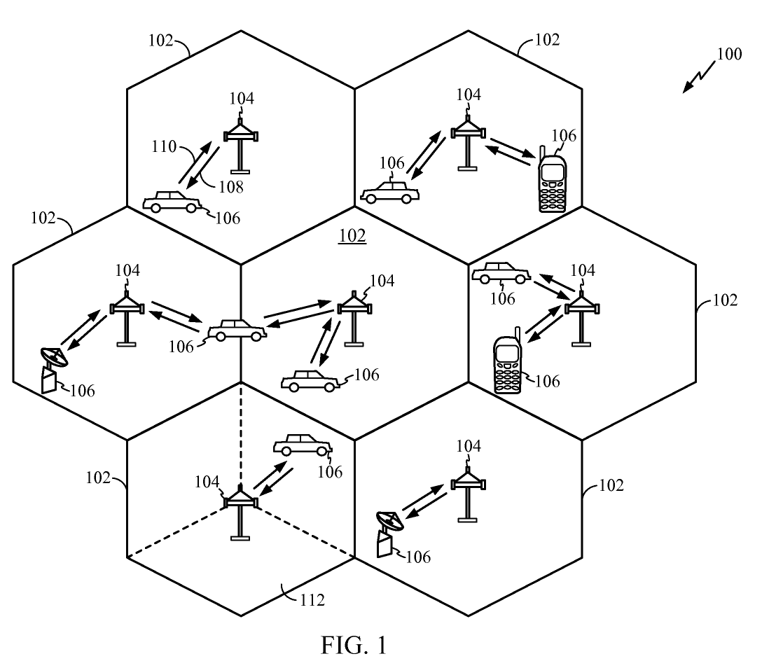

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

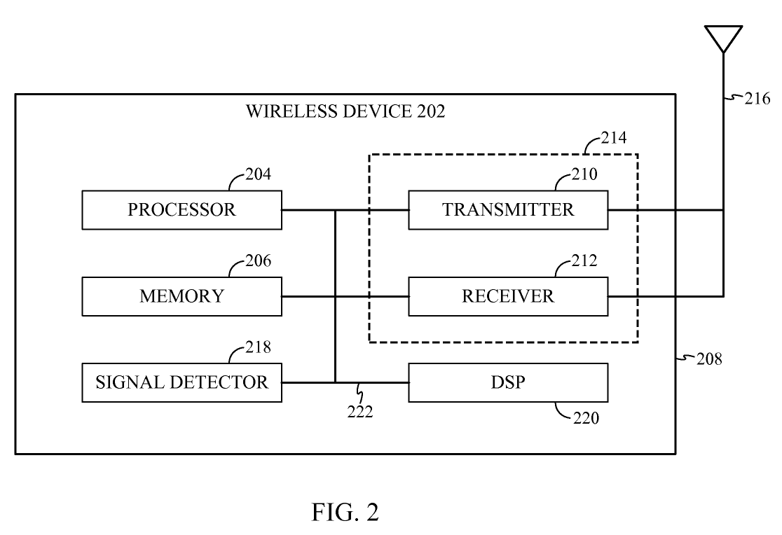

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

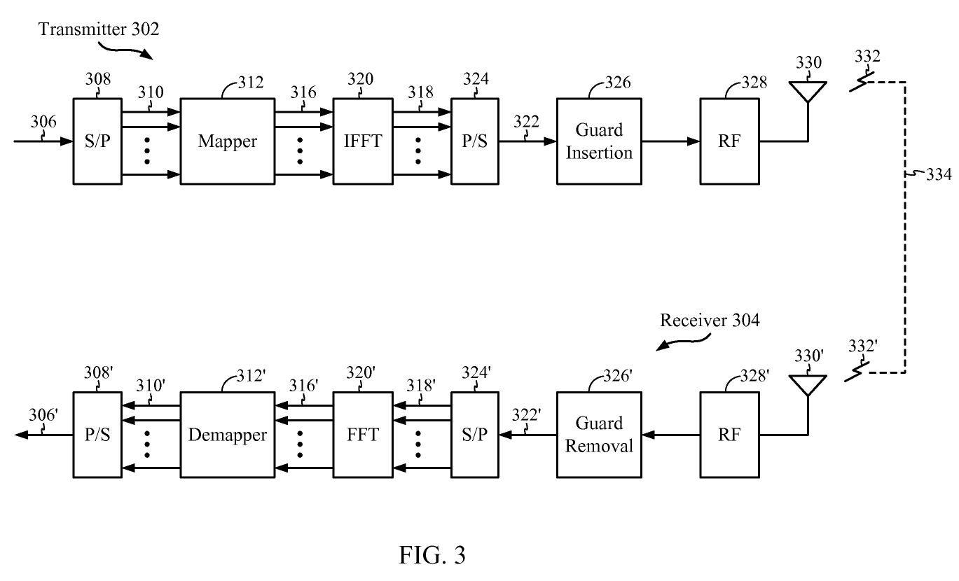

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 3 12. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Ns, is equal to Nₑₚ (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

Exemplary Technique for a Multi-Mode Mobile Station to Align CDMA EVDO Paging Intervals with the Overlaid WiMAX Network

In the deployment of wireless services, a mobile device may support different radio access technologies (RATs) to provide an end user access to multiple services. For example, a multi-mode MS may support WiMAX and code division multiple access evolution-data optimized (CDMA EVDO) technologies for broadband data services. This may result in instances in which the multi-mode MS may be in a sleep mode in both the CDMA EVDO and the WiMAX networks, requiring the MS to listen for traffic indication messages in both networks.

Unfortunately, a multi-mode MS with a single RF chain may only listen to one system at a time, and there is also a very low probability that the CDMA and WiMAX networks are naturally configured so as to prevent an overlap of their respective listening intervals. Consequently, there may be instances in which a conventional MS with a single RF chain may miss one or more listening intervals of at least one of its supported networks due to a conflict between the listening intervals of the networks.

Accordingly, embodiments of the present disclosure may enable a multi-mode MS to configure a sleep cycle between the MS and one or more of the RATs such that the listening intervals of one RAT align with the sleep intervals of other supported RATs.

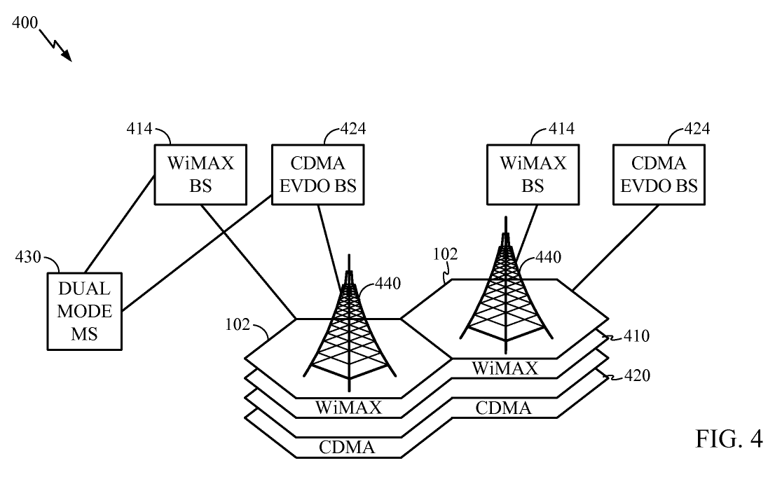

FIG. 4 illustrates an example system 400 in which mobile WiMAX network 410 may be combined with (or “overlaid” on) a CDMA EVDO network 420 to provide broadband data service. In the system, subscribers may employ a single multi-mode mobile station (MS) 430 to tune to both the CDMA EVDO network 420 and the WiMAX network 410 to utilize broadband data service.

FIG. 4 further illustrates that CDMA service may be provided to a geographic area by a plurality of hardware and software components. This geographic area may be divided into regions, referred to as cells 102, centered around a service tower 440. In an attempt to increase spatial efficiency, a single service tower 440 may support multiple RATs. For example, a service tower 440 may support both a WiMAX base station (BS) 414 as well as a CDMA EVDO BS 424.

In the CDMA EVDO network, as in the WiMAX network, an MS 430 in sleep mode may wake up and listen for a traffic indication message during recurrent listening intervals that correspond to network paging intervals. Under current CDMA EVDO standards, an MS 430 in a sleep mode may negotiate a specific control channel cycle (CCC) that corresponds to the recurrent paging intervals of the CDMA EVDO network 420. Each CCC lasts approximately 426.67 ms and may be divided into 256 slots each with a duration of 1.67 (or 5/3) milliseconds.

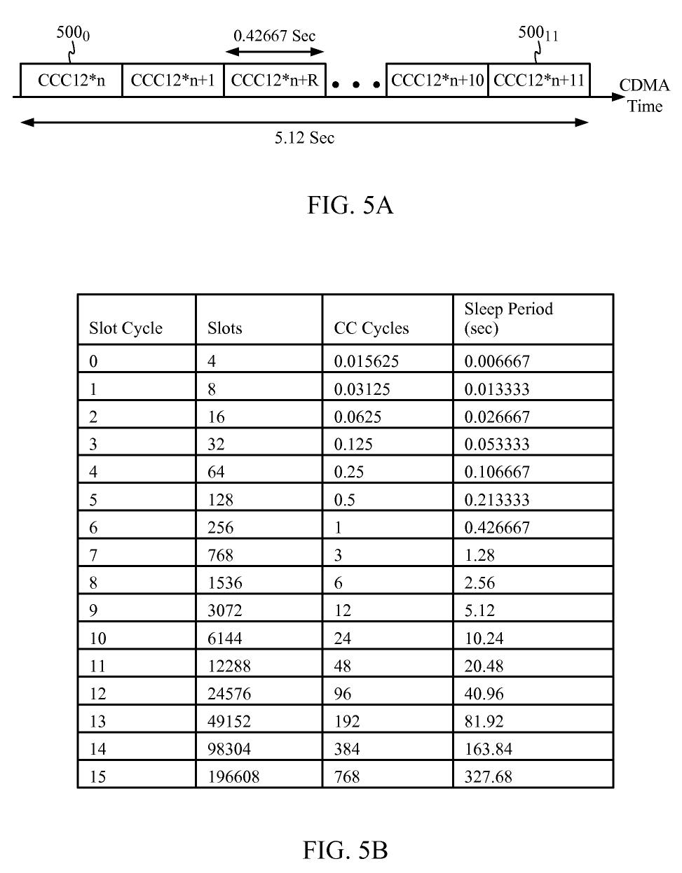

In EVDO rev 0, the low power state protocol may allow the MS 430 to wake-up for one CCC every 5.12 seconds, where 12 CCCs 500₀₋₁₁ are available during 5.12 seconds, as illustrated in FIG. 5A. Additionally, each CCC has an index starting from the beginning of the CDMA system time. An MS 430, in a CDMA EVDO network may wake-up on a CCC with index C where the value of C satisfies Equation 1:

(C+R)mod12=0, (1)

where the parameter ‘R’ may be set by either a random generation algorithm specified in the CDMA standard or an MS preferred value, called a Preferred CCC.

Under EVDO rev 0, an MS 430 may choose one of the previous two options by setting a Preferred CCC enable parameter. If the MS 430 decides to set the Preferred CCC, the MS 430 may use a generic configuration protocol in an EVDO configuration request message. However, under CDMA EVDO rev A, an enhanced sleep mode protocol may allow the MS 430 to sleep for one of a plurality of possible periods, as illustrated in FIG. 5B. The sleep period may range from 4 slots (or 1/64 of a CCC) to 196,608 slots (or 768 CCCs). Despite the available choices, in the interest of power consumption, embodiments of the present disclosure focus on sleep periods longer than 1 CCC (i.e., a slot cycle value greater than or equal to 7).

Additionally, CDMA EVDO rev A protocols allow an MS 430 to enter a sleep mode with graduated sleep periods. For example, the MS 430 may have 3 sleep periods of different lengths. The first sleep period Period1 may be one CCC, or 426.67 milliseconds, the second sleep period Period2 may be three CCCs, or 1.28 seconds, and the third sleep period Period3 may be six CCCs, or 2.56 seconds. However, the Period3 may represent the final sleep period and will be used for reference for the remainder of the disclosure. Period3 is in units of CDMA EVDO slots.

CDMA EVDO rev A goes on to specify that an MS 430 may wake-up at a slot within a CCC described by Equation 2:

[T+256*R]mod P=Offset, (2)

where the offset is the number of slots from the beginning of the selected CCC. This is in fact equivalent to CCC index C satisfying Equation 1, where P=Period3/256. It should be noted that R may be set under EVDO rev A as it is set under EVDO rev 0, either by a random number generation or by a Preferred CCC.

Since the MS 430 knows the timing of its selected CCC within the CDMA EVDO network and the corresponding sleep and monitoring intervals, the MS 430 may configure a WiMAX sleep cycle in such a ways as to align some of the WiMAX sleep intervals with the CDMA EVDO monitoring intervals, enabling the MS 430 to listen for traffic indication or paging messages in both networks.

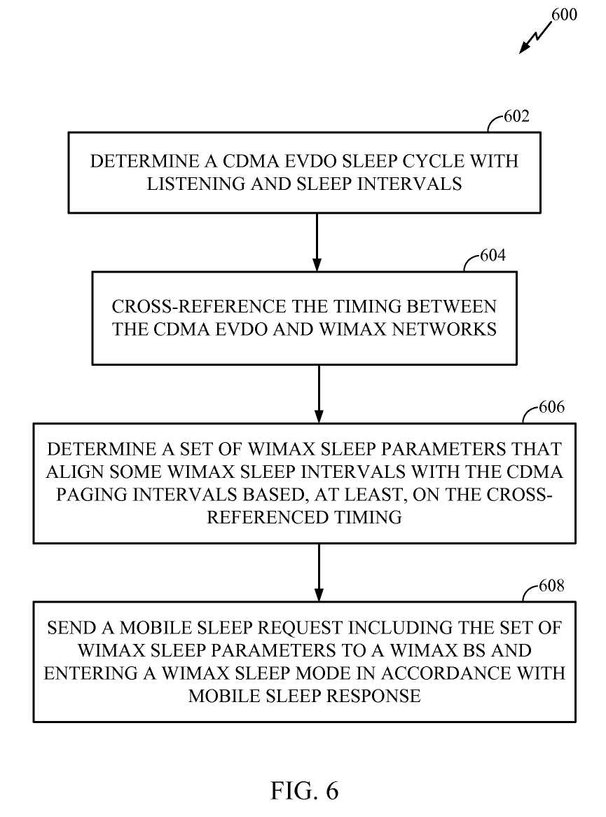

FIG. 6 illustrates example operations 600 that may be performed by a multi-mode MS 430, for configuring a WiMAX sleep cycle in such a manner as to allow the MS 430 to listening to both a WiMAX RAT and a CDMA EVDO RAT with a single RF chain, in accordance with certain embodiments of the present disclosure. The operations 600 may be performed, for example, by an MS in a sleep interval of a CCC in an effort to allow the MS to align some of the WiMAX sleep intervals with the CDMA EVDO monitoring intervals.

Operations begin, at 602, with the MS 430 determining a CDMA EVDO control channel cycle with monitoring intervals and sleep intervals. Since the MS 430 negotiated the CCC with CDMA EVDO network, the MS 430 knows the corresponding timing of the monitoring intervals and sleep intervals within the selected CCC.

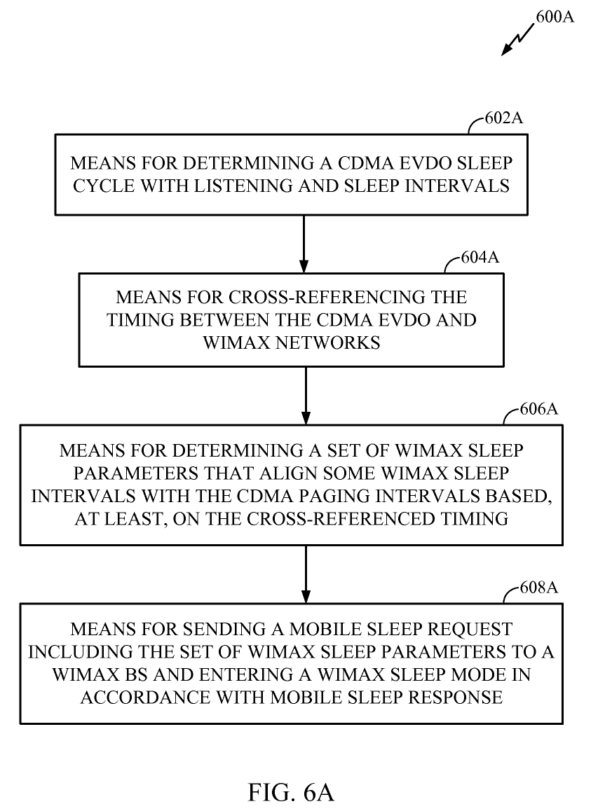

At 604, the MS 430 may cross-reference the timing between the CDMA EVDO network and the WiMAX network. For example, the MS 430 may compare the CDMA EVDO system time N2 712 (in slots) with the corresponding WiMAX frame number N1 710, as illustrated in FIG. 7.

It should be noted that certain embodiments may assume the duration of a WiMAX frame (wmx_frame) is 2, 2.5, 5, 10, or 20 milliseconds. However, current versions of the IEEE 802.16 standard only support a frame duration of 5 milliseconds.

At 606, the MS 430 may determine a set of WiMAX sleep parameters that align some WiMAX sleep intervals with the CDMA EVDO monitoring intervals based at least, on the cross-referenced timing between the CDMA EVDO network and the WiMAX network. For example, the MS 430 may determine a 7-bit WiMAX start frame number, an 8-bit WiMAX initial sleep window, and an 8-bit WiMAX listening interval.

In certain embodiments, the determination of the 8-bit WiMAX initial sleep window S_{WiMAX} (in WiMAX frames) may be described by Equation 3:

S_{WiMAX}=(426.67 ms/wmx_frame+d (3)

where d represents a number of additional WiMAX frames reserved for the MS 430 to tune from the WiMAX network 410 to the CDMA EVDO network 420 or to allow for a margin for timing errors or fractional frames resulting from the application of Equation 3. The additional reserved frames are seen in addition to the number of WiMAX frames necessary to cover a CDMA EVDO control channel cycle. Additionally, embodiments utilizing Equation 3 in determining the WiMAX initial sleep window, may do so in CDMA EVDO networks compliant with revision 0 (rev0) or revision A (revA) of the CDMA EVDO standard.

Moreover, the MS 430 may determine the 8-bit WiMAX listening interval based, at least on, the revision of the CDMA EVDO standard with which the current EVDO network is compliant. For example, embodiments may utilize Equation 4 in determining the WiMAX listening interval when the MS 430 is in a CDMA EVDO network compliant with rev0 of the CDMA EVDO standard:

$${Listening\_Interval}_{WiMAX} = max \{ \begin{matrix}k < 25 , where \\ \frac{\frac{5.12 sec}{wmx\_frame}}{{S}_{WiMAX} + k} = Positive\_Integer\end{matrix} \} \qquad ( 4 )$$

In contrast, embodiments may utilize Equation 5 in determining the WiMAX listening interval when the MS 430 is in a CDMA EVDO network compliant with revA of the CDMA EVDO standard:

$${Listening\_Interval}_{WiMAX} = max \{ \begin{matrix}k < 256 , where \\ \frac{Period 3 * \frac{5}{3} \frac{ms}{wmx\_frame}}{{S}_{WiMAX} + k} = Positive\_Integer\end{matrix} \} \qquad ( 5 )$$

To illustrate these examples, consider an instance in which the MS 430 is in both a WiMAX network and a CDMA EVDO revA network, the WiMAX frame duration (wmx_frame) equals 5 ms, and the duration of the final sleep period (Period3) in the CDMA EVDO network equals 1536 slots. The MS 430 may then determine the initial WiMAX sleep window S_{WiMAX} to equal the sum of d and the quotient of 426.67 ms divided by 5 ms or, simply, the sum of d and 85.3. If the MS 430 selected a value for d equal to 2.7, then the initial WiMAX sleep window S_{WiMAX} would be 88 WiMAX frames.

Since the MS 430 is in a CDMA EVDO revA network, the MS 430 may employ Equation 5 in determining the WiMAX listening interval. The implementation of Equation 5 might yield the max value of a set of k values wherein the quotient of 512 divided by 88+k is a positive integer. Accordingly, the set of k values would include the values of 40 and 168, and the WiMAX listening interval would be 168.

Additionally, in determining the set of WiMAX sleep parameters, the MS 430 may determine a 7-bit WiMAX start frame number, wherein the 7 bits are the least significant 7 bits of the absolute WiMAX frame number. As with the WiMAX listening interval, certain embodiments may determine the WiMAX start frame number based on the revision of the CDMA EVDO standard with which the current EVDO network is compliant. For example, embodiments may utilize Equation 6 in determining the WiMAX start frame number when the MS 430 is in a CDMA EVDO network compliant with rev0 of the CDMA EVDO standard:

$$Start\_Frame \_Number = ( M * \frac{\frac{5}{3} ms}{wmx\_frame} + N 1 - {d}^{′} ) mod 128 , \qquad ( 6 )$$

where M=(R*256−N2) mod 3072 when the MS 430 is in a CDMA EVDO rev0 network and where M=(R*256−N2) mod Period3 when the MS 430 is in a CDMA EVDO revA network. The variable d' represents a design factor that may be used to make the Frame Number obtained using Equation (6) an integer and cover the MS tuning time, for example, from the WiMAX network 410 to the CDMA network EVDO network 420. It should be noted that there are a total of 3072 CDMA slots during the 5.12 seconds of 12 CCCs.

At 608, the MS 430 may send a WiMAX mobile sleep request (MOB_SLP-REQ) including the set of WiMAX sleep parameters to a WiMAX BS 414. After receiving a response from the WiMAX BS 414 acknowledging the sleep request, the MS 430 may enter a WiMAX sleep mode in accordance with the MOB_SLP-RSP.

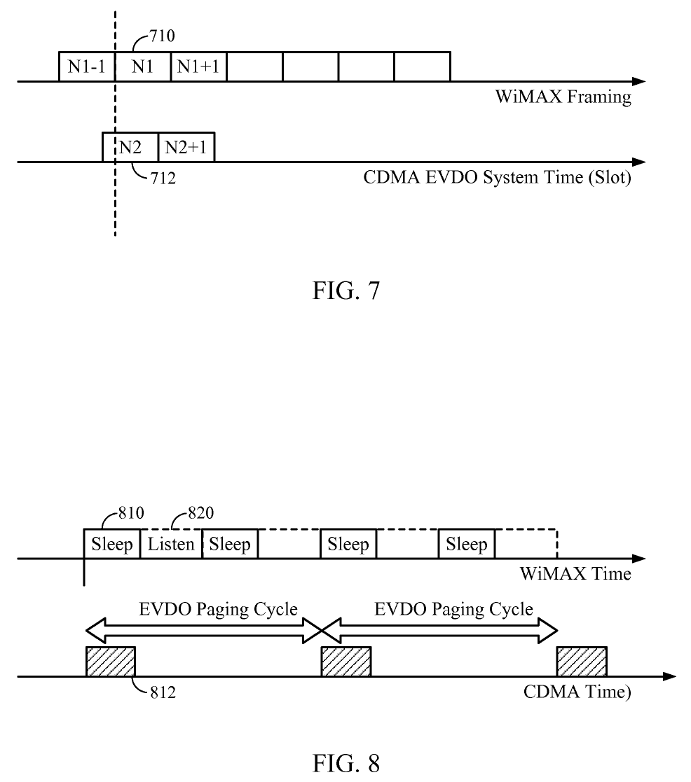

FIG. 8 illustrates an example of a WiMAX sleep cycle in which some of the sleep windows 810 cover the intervals of the CCC 812 of the CDMA EVDO network, in accordance with embodiments of the present disclosure. It should be noted that there may be some WiMAX sleep windows 810 in which the MS does not tune to the CDMA EVDO network. This may result from the 8-bit listening window constraint (or a maximum of 256 WiMAX frames) found in versions of the IEEE 802.16 standard.

Additionally, current versions of the IEEE 802.16 standard provide for a 7-bit start frame number in the MOB_SLP-REQ; however, both the sleep and listening windows may be 256 frames long. Accordingly, there may be instances in which it is needed to avoid the sleep cycle being offset by 128 frames.

Though there are two frames within every 256 frames with an identical least significant 7 bits, the current version of the IEEE 802.16 standard limit the WiMAX start frame number to 7 bits. Since the standard also requires a WiMAX sleep cycle to being with a sleep interval 810, if a MOB_SLP-REQ 900 is sent more than 127 frames prior to the desired start frame, the WiMAX BS 414 may establish the WiMAX sleep cycle at the wrong start frame number.

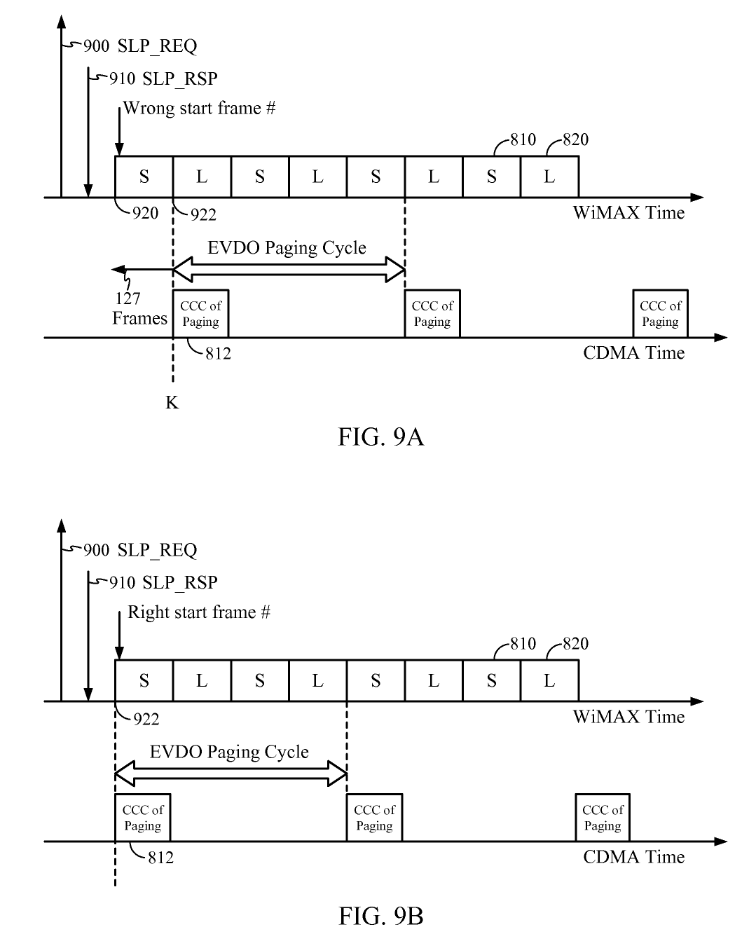

FIG. 9A illustrates a MOB_SLP-REQ message 900 being sent more than 127 frames prior to the desired start frame 922. As a result, the WiMAX BS may establish a sleep cycle beginning at the incorrect frame 920. Note that both the incorrect frame 920 and the correct frame 922 have an identical least significant 7 bits.

To prevent an incorrect alignment of the WiMAX sleep cycle and the CDMA EVDO CCC, certain embodiments may send the MOB_SLP-REQ message 900 L frames prior to the next WiMAX absolute frame number with the least significant 8 bits identical to a parameter K, wherein K is an 8-bit start frame number. As with the 7-bit start frame number, certain embodiments may determine the parameter K based on the revision of the CDMA EVDO standard with which the current EVDO network is compliant. For example, embodiments may utilize Equation 7 in determining the WiMAX start frame number when the MS 430 is in a CDMA EVDO network compliant with rev0 of the CDMA EVDO standard:

$$K = ( M * \frac{\frac{5}{3} ms}{wmx\_frame} + N 1 - {d}^{′} ) mod 256 , \qquad ( 7 )$$

where M=(R*256−N2) mod 3072 when the MS 430 is in a CDMA EVDO rev0 network and where M=(R*256−N2) mod Period3 when the MS 430 is in a CDMA EVDO revA network. The value L may be chosen such that the WiMAX BS 414 is able to reply to the MS 430 with a mobile sleep response (MPB_SLP-RSP) message no more than 127 frames before the next absolute frame number with the least significant 8 bits identical to K. For example, L may be less than or equal to 127.

Simply stated, in certain embodiments, the MS 430 may determine an 8-bit WiMAX start frame number. The MS 430 may, then, send a MOB_SLP-REQ message 900 containing the least significant 7 bits of the 8-bit WiMAX start frame number during a frame approximately L frames prior to the next WiMAX absolute frame number with the least significant 8 bits identical to the 8-bit WiMAX start frame number.

FIG. 9B illustrates a MOB_SLP-REQ message 900 with a 7-bit start frame number, being sent L frames prior to the next WiMAX absolute frame number with the least significant 8 bits identical to the 8-bit WiMAX start frame number. As a result, the WiMAX BS may establish a sleep cycle beginning at the correct frame 922.

The various operations of methods described above may be performed by various hardware and/or software component(s) and/or module(s) corresponding to means-plus-function blocks illustrated in the Figures. Generally, where there are methods illustrated in Figures having corresponding counterpart means-plus-function Figures, the operation blocks correspond to means-plus-function blocks with similar numbering. For example, blocks 602-608 illustrated in FIG. 6 correspond to means-plus-function blocks 602A-608A illustrated in FIG. 6A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated in the Figures, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to embodiments of the present disclosure, other and further embodiments of the disclosure may be devised without departing from the basic scope thereof, and the scope thereof is determined by the claims that follow.

What is claimed is:

1. A method for communicating, by a multi-mode mobile station (MS), with first and second networks via first and second radio access technologies (RATs), comprising:
determining a first set of one or more paging parameters in an effort to establish a listening interval of a sleep cycle of the first network that aligns with a sleep interval of a control channel cycle of the second network; and
communicating the first set of paging parameters to a base station of the first network in a request to establish the sleep cycle of the first network.

2. The method of claim 1, wherein the first set of one or more paging parameters comprises a listening interval duration, an initial sleep window duration, and a start frame number.

3. The method of claim 2, wherein communicating the first set of paging parameters comprises, sending a mobile sleep request including the listening interval duration, the initial sleep window duration, and the start frame number.

4. The method of claim 1, wherein determining the first set of one or more paging parameters comprises:
determining a control channel cycle of the second network;
cross-referencing a timing difference between frames of the first and second networks; and
determining the first set of one or more paging parameters sleep cycle of the first network based, at least in part, on the control channel cycle of the second network and the cross-referenced timing between frames of the first and second networks.

5. The method of claim 1, wherein determining a first set of one or more paging parameters in an effort to establish a sleep interval of the first network that aligns with the sleep interval of the second network comprises:
determining a WiMAX listening interval duration, a WiMAX initial sleep window duration, and a WiMAX start frame number based on parameters of a code division multiple access evolution-data optimized (CDMA EVDO) control channel cycle.

6. An apparatus for communicating with first and second networks via first and second radio access technologies (RATs), comprising:
logic for determining a first set of one or more paging parameters in an effort to establish a listening interval of a sleep cycle of the first network that aligns with a sleep interval of a control channel cycle of the second network; and
logic for communicating the first set of paging parameters to a base station of the first network in a request to establish the sleep cycle of the first network.

7. The apparatus of claim 6, wherein the first set of one or more paging parameters comprises a listening interval duration, an initial sleep window duration, and a start frame number.

8. The apparatus of claim 7, wherein the logic for communicating the first set of paging parameters comprises, logic for sending a mobile sleep request including the listening interval duration, the initial sleep window duration, and the start frame number.

9. The apparatus of claim 6, wherein the logic for determining the first set of one or more paging parameters comprises:
logic for determining a control channel cycle of the second network;
logic for cross-referencing a timing difference between frames of the first and second networks; and
logic for determining the first set of one or more paging parameters sleep cycle of the first network based, at least in part, on the control channel cycle of the second network and the cross-referenced timing between frames of the first and second networks.

10. The apparatus of claim 6, wherein the logic for determining a first set of one or more paging parameters in an effort to establish a sleep interval of the first network that aligns with the sleep interval of the second network comprises:
logic for determining a WiMAX listening interval duration, a WiMAX initial sleep window duration, and a WiMAX start frame number based on parameters of a code division multiple access evolution-data optimized (CDMA EVDO) control channel cycle.

11. An apparatus for communicating with first and second networks via first and second radio access technologies (RATs), comprising:
means for determining a first set of one or more paging parameters in an effort to establish a listening interval of a sleep cycle of the first network that aligns with a sleep interval of a control channel cycle of the second network; and
means for communicating the first set of paging parameters to a base station of the first network in a request to establish the sleep cycle of the first network.

12. The apparatus of claim 11, wherein the first set of one or more paging parameters comprises a listening interval duration, an initial sleep window duration, and a start frame number.

13. The apparatus of claim 12, wherein the means for communicating the first set of paging parameters comprises, means for sending a mobile sleep request including the listening interval duration, the initial sleep window duration, and the start frame number.

14. The apparatus of claim 11, wherein the means for determining the first set of one or more paging parameters comprises:
means for determining a control channel cycle of the second network;
means for cross-referencing a timing difference between frames of the first and second networks; and
means for determining the first set of one or more paging parameters sleep cycle of the first network based, at least in part, on the control channel cycle of the second network and the cross-referenced timing between frames of the first and second networks.

15. The apparatus of claim 11, wherein the means for determining a first set of one or more paging parameters in an effort to establish a sleep interval of the first network that aligns with the sleep interval of the second network comprises:
means for determining a WiMAX listening interval duration, a WiMAX initial sleep window duration, and a WiMAX start frame number based on parameters of a code division multiple access evolution-data optimized (CDMA EVDO) control channel cycle.

16. A computer program product for communicating with first and second networks via first and second radio access technologies (RATs), the computer program product comprising a computer-readable medium having instructions stored thereon, the instructions being executable by one or more processors and the instructions comprising:
instructions for determining a first set of one or more paging parameters in an effort to establish a listening interval of a sleep cycle of the first network that aligns with a sleep interval of a control channel cycle of the second network; and
instructions for communicating the first set of paging parameters to a base station of the first network in a request to establish the sleep cycle of the first network.

17. The computer program product of claim 16, wherein the first set of one or more paging parameters comprises a listening interval duration, an initial sleep window duration, and a start frame number.

18. The computer program product of claim 17, wherein the instructions for communicating the first set of paging parameters comprise, instructions for sending a mobile sleep request including the listening interval duration, the initial sleep window duration, and the start frame number.

19. The computer program product of claim 16, wherein the instructions for determining the first set of one or more paging parameters comprise:
instructions for determining a control channel cycle of the second network;
instructions for cross-referencing a timing difference between frames of the first and second networks; and
instructions for determining the first set of one or more paging parameters sleep cycle of the first network based, at least in part, on the control channel cycle of the second network and the cross-referenced timing between frames of the first and second networks.

20. The computer program product of claim 16, wherein instructions for determining a first set of one or more paging parameters in an effort to establish a sleep interval of the first network that aligns with the sleep interval of the second network comprise:
instructions for determining a WiMAX listening interval duration, a WiMAX initial sleep window duration, and a WiMAX start frame number based on parameters of a code division multiple access evolution-data optimized (CDMA EVDO) control channel cycle.
